(19) United States
(12) Patent Application Publication
(10) Pub. No.: US 2020/0028986 A1
(43) Pub. Date: Jan. 23, 2020

(54) IMAGE READING DEVICE AND IMAGE FORMING APPARATUS

(71) Applicant: KYOCERA Document Solutions Inc., Osaka (JP)

(72) Inventors: Yuya TAGAMI, Osaka (JP); Sachiko SHINTANI, Osaka (JP)

(73) Assignee: KYOCERA Document Solutions Inc., Osaka (JP)

(21) Appl. No.: 16/510,631

(22) Filed: Jul. 12, 2019

(30) Foreign Application Priority Data
Jul. 18, 2018 (JP) 2018-135320

(51) Int. Cl. H04N 1/387; H04N 1/00; H04N 1/393

(52) U.S. Cl. CPC H04N 1/3876; H04N 1/00482; H04N 2201/0094; H04N 1/393; H04N 1/3878

(57) ABSTRACT

An image reading device has an image reading portion, a control portion, and an operation portion. The image reading portion reads, by irradiating with light, a predetermined reading region including a region where a document is present. The control portion processes the image data read by the image reading portion. On the operation portion, instructions are input to the control portion. The control portion can operate in a consolidation mode where the read image data is consolidated to generate processed image data when the image reading portion reads image data of a previously set number of to-be-consolidated sheets. In the consolidation mode, when the number of sheets of read image data is smaller than the previously set number of to-be-consolidated sheets, on input of an instruction on the operation portion, the processed image data is generated based on the image data read before the instruction input.

### INCORPORATION BY REFERENCE

This application is based upon and claims the benefit of priority from the corresponding Japanese Patent Application No. 2018-135320 filed on Jul. 18, 2018, the entire contents of which are incorporated herein by reference.

### BACKGROUND

The present disclosure relates to an image reading device and an image forming apparatus incorporating an image reading device.

A conventional image forming apparatus is provided with a reading means, an accumulating means, and a consolidating means. The reading means is for electrically reading a document. The accumulating means is for accumulating image data of the read document. The consolidating means is for consolidating the image data accumulated by the accumulating means.

So it is possible, for example, to read the obverse and reverse sides of a business card by the reading means and to consolidate the image data of the obverse and reverse sides. It is thus possible to print the image data of the obverse and reverse sides in a pair. When it is determined that the total number of documents read by the reading means is smaller than the previously set total number of sheets, after the lapse of a given time, the image data accumulated by the accumulating means is discarded.

In the conventional image forming apparatus, the number of sheets of which the image data is consolidated is previously determined in settings. Here, even when the reverse side of the business card is blank, it is necessary to read the image data of the blank reverse side to obtain consolidated image data. Thus, a user needs to read unnecessary image data of the reverse side, resulting in low operability in reading. Moreover, unnecessary blank image data is included in the consolidated image data, resulting in low efficiency in management of image data.

### SUMMARY

According to one aspect of the present disclosure, an image reading device includes an image reading portion, a control portion, and an operation portion. The image reading portion irradiates with light a predetermined reading region including a region where a document is present and reads the reading region. The control portion performs image processing on image data read by the image reading portion. On the operation portion, a user performs instruction input with respect to the control portion. The control portion can operate in a consolidation mode in which the read image data is consolidated to generate image data when the image reading portion has read image data corresponding to a previously set number of sheets to be consolidated. In the consolidation mode, when the number of sheets from which image data is read is smaller than the previously set number of sheets to be consolidated, in response to instruction input on the operation portion, the processed image data is generated based on the image data read before the instruction input.

According to another aspect of the present disclosure, an image forming apparatus includes the image reading device.

Further features and advantages of the present disclosure will become apparent from the description of embodiments given below.

### BRIEF DESCRIPTION OF THE DRAWINGS

FIG. 1 is a schematic diagram showing an overall structure of an image forming apparatus according to one embodiment of the present disclosure;

FIG. 2 is a block diagram showing a configuration of an image reading device according to the one embodiment of the present disclosure;

FIG. 3 is a flow chart showing operation of the image reading device according to the one embodiment of the present disclosure;

FIG. 4 is a plan view showing a display screen displayed on a display portion in the image reading device according to the one embodiment of the present disclosure;

FIG. 5 is a plan view showing a display screen displayed on the display portion in the image reading device according to the one embodiment of the present disclosure; and

FIG. 6 is a diagram showing edited data generated by the image reading device according to the one embodiment of the present disclosure.

### DETAILED DESCRIPTION

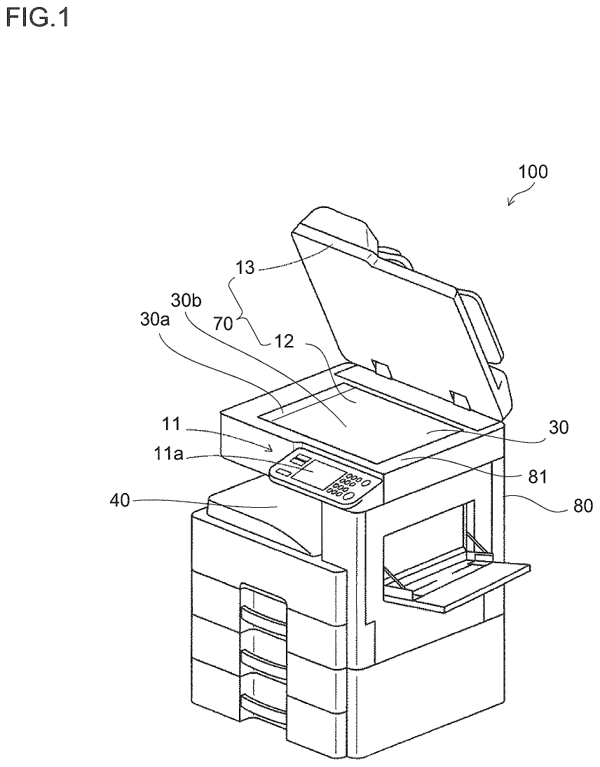

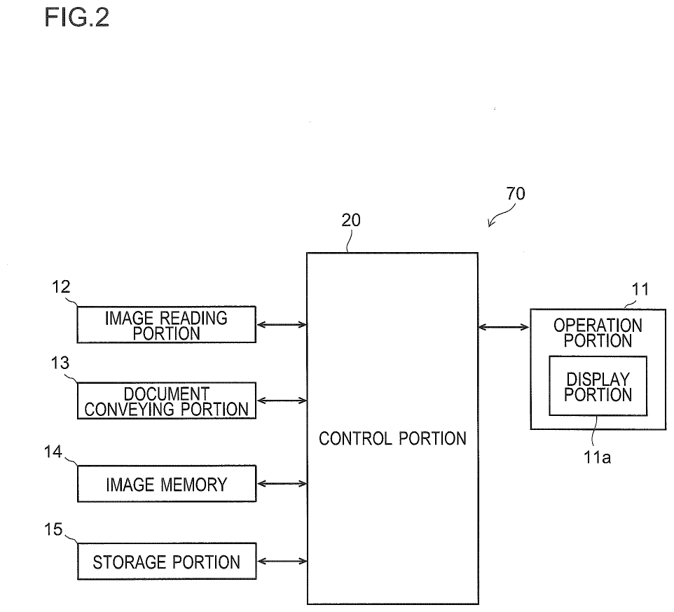

A description will be given of an image reading device according to one embodiment of the present disclosure and an image forming apparatus incorporating it. The following description deals with, as an example, a multifunction peripheral having a plurality of functions such as a scanning function and a printing function. FIG. 1 is a schematic diagram showing an overall structure of an image forming apparatus 100 according to the present disclosure. FIG. 2 is a block diagram showing a configuration of an image reading device 70 included in the image forming apparatus 100 according to the present disclosure.

The image forming apparatus 100 is a multifunction peripheral provided with a plurality of functions such as a copying function, a printing function, a scanning function, and a facsimile function. The image forming apparatus 100 includes an apparatus main body 80 and the image reading device 70.

The apparatus main body 80 has, inside a housing 81, a sheet feed portion, an image forming portion, and the like, though none of these are illustrated. Based on image data generated by the image reading device 70, the image forming portion forms a toner image of an image to be printed on a sheet (recoding medium) conveyed from the sheet feed portion. The sheet having the image formed on it is discharged onto a discharge tray 40.

The image reading device 70 is arranged over the apparatus main body 80 and is provided with a control portion 20, an operation portion 11, an image reading portion 12, a document conveying portion 13, an image memory 14, and a storage portion 15.

On the operation portion 11, a user performs instruction input to input instructions such as for image forming operation and document reading operation out of various kinds of operation and processing that the image reading device 70 and the image forming apparatus 100 can perform. Specifically, the operation portion 11 includes a Start button, which the user operates to start image formation; a Stop/Clear button, which the user uses, among others, to stop image formation; and a Reset button, which the user uses to bring the various settings of the image forming apparatus 100 back to the default settings.

The operation portion 11 also includes a display portion 11a that displays guidance and the like on instruction input by the user. The display portion 11a is a touch panel. By touching buttons and keys displayed on a display screen on the display portion 11a, the user can perform instruction input with respect to the image reading device 70 and the image forming apparatus 100.

The image reading portion 12 has a contact glass 30 which functions as a document placement stage. The contact glass 30 is fitted in an opening provided in the top face of the housing 81. The image reading portion 12 irradiates a document placed on the contact glass 30 with light from a light emitting portion (unillustrated) arranged under the contact glass 30, and reads an image of the document from the received reflected light.

The contact glass 30 is divided into a conveying reading region 30a and a placement reading region (reading region) 30b. In the conveying reading region 30a, the image reading portion 12 reads an image of the document conveyed from the document conveying portion 13. In the placement reading region 30b, the image reading portion 12 reads an image of the placed document. In the placement reading region 30b, the image reading portion 12 can read an image of a business card or the like, which is smaller than a standard document.

The document conveying portion 13 conveys a document which is the reading target to the image reading portion 12. The document conveying portion 13 is fitted so as to be openable and closable with respect to the top face of the image reading portion 12 with a hinge or the like. The document conveying portion 13 functions as a document pressing cover when the document placed on the placement reading region 30b is read.

The image memory 14 temporarily stores image data of the document read by the image reading portion 12.

The storage portion 15 is a storage device with a large capacity such as a HDD (hard disc drive). The storage portion 15 stores programs and data required for the operation of the image forming apparatus 100 and the image reading device 70.

The control portion 20 includes, among others, a CPU (central processing unit) which is a central processing device, and comprehensively controls the operation of the image reading device 70 and the image forming apparatus 100. The different blocks and devices controlled by the control portion 20 include, for example, the operation portion 11, the image reading portion 12, the document conveying portion 13, the image memory 14, the storage portion 15, the image forming portion (unillustrated), and the sheet feed portion (unillustrated).

By executing control programs stored in the storage portion 15, the control portion 20 performs image processing on the read image data. For example, the control portion 20 analyzes image data of the document read by the image reading portion 12 and cuts out a part of it along the edges of the document (automatic cropping). The control portion 20 performs rotating processing with respect to the cut-out image data and thereby corrects the inclination of the image data.

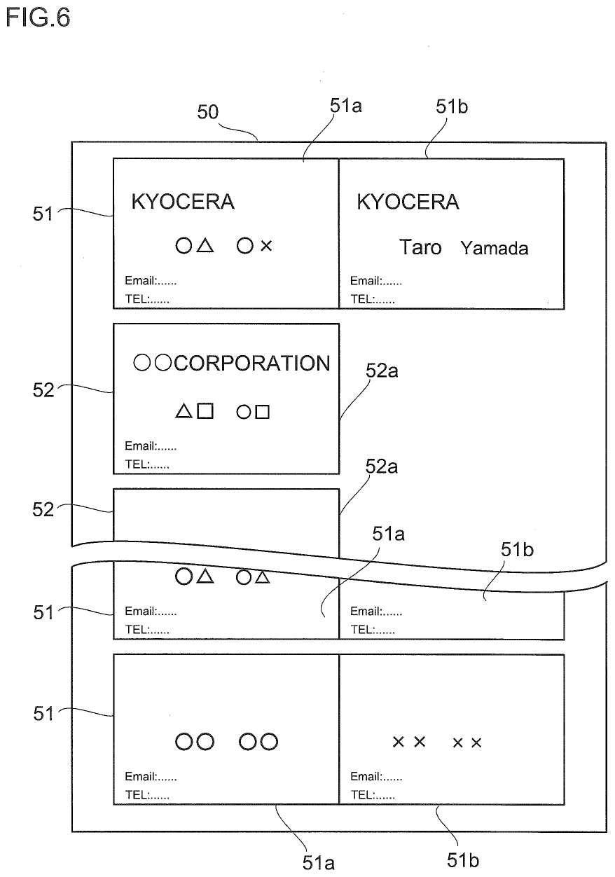

The image reading device 70 according to the present disclosure is configured to be able to operate in a consolidation mode. In the consolidation mode, when the image reading portion 12 has read image data corresponding to a previously set number of sheets to be consolidated, the read image data is consolidated, and thereby processed image data 51 (see FIG. 6) is generated.

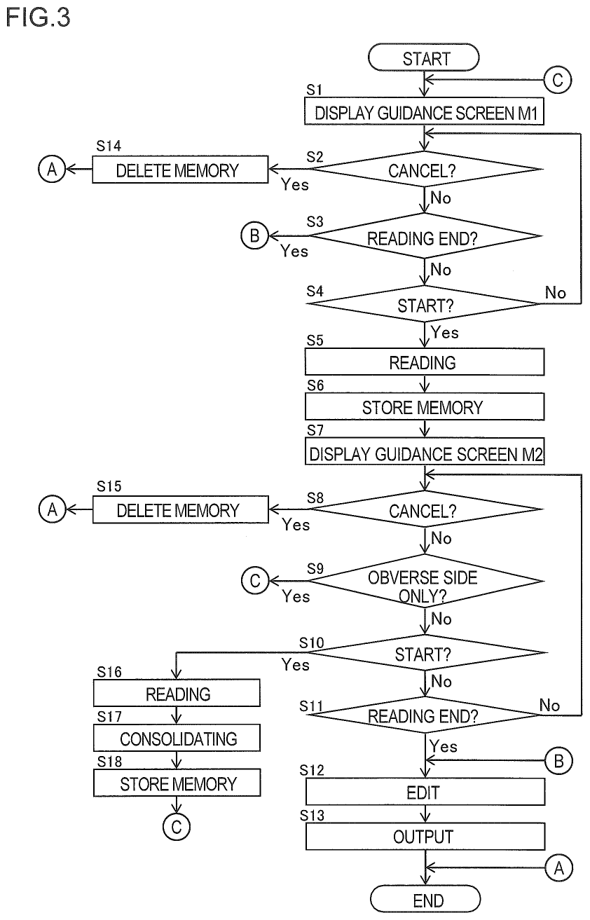

FIG. 3 is a flow chart showing the operation of the image reading device 70. With reference to FIGS. 1 and 2 as necessary, a procedure for the consolidation mode will be described more specifically along the steps in FIG. 3.

In this embodiment, as an example of the operation of the image reading device 70, the operation in the consolidation mode with respect to a business card which is a kind of card document will be described. In the consolidation mode with respect to the business card, the number of sheets to be consolidated has been previously set to two, and when the image data of the obverse and reverse sides of the business card is read, the image data of the obverse and reverse sides is consolidated, and thereby so-called two-in-one processed image data 51 (see FIG. 6) is generated. If there is an image only on the obverse side but no image on the reverse side, a user performs instruction input on the operation portion 11 so that processed image data 52 (see FIG. 6) is generated based on the image data of the obverse side read before the instruction input.

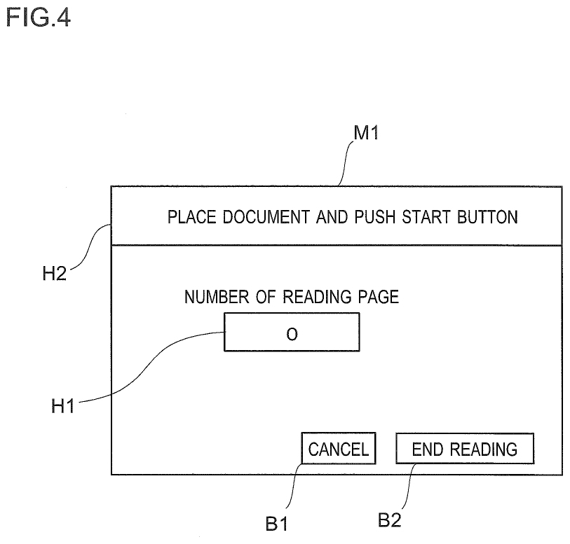

When a user operates the operation portion 11 to handle a business card in the consolidation mode, at step S1, a guidance screen M1 as shown in FIG. 4 is displayed on the display portion 11a, and the flow proceeds to step S2.

On the guidance screen M1, operation buttons B1 and B2 are arranged. The operation button B1 is labeled as “Cancel”, and the operation button B2 is labeled as “End reading”. A display field H1 is arranged in a middle part of the guidance screen M1, and the display field H1 indicates that “Number of pages read” is “0”. A display field H2 is arranged in an upper part of the guidance screen M1, and the display field H2 displays “Place document and press Start button”.

The user confirms that the display field H1 indicates that “Number of pages read” is “0” and enters an instruction to start reading the obverse side. Specifically, the business card is placed in the placement reading region 30b of the image reading portion 12 with the obverse side down. Here, the control portion 20 performs automatic cropping and rotating processing on the image data of the business card, and thus there is no need to place the business card in a way aligned with the main or sub scanning direction. This improves the operability when business cards are read.

At steps S2, S3, and S4, it is checked whether or not the control portion 20 accepts instruction input displayed on the guidance screen M1. Specifically, if the user operates the operation button B1 labeled as “Cancel” on the touch panel, the flow proceeds to step S14. At step S14, if there is data temporarily stored in the image memory 14, it is deleted, and the consolidation mode ends. If the operation button B1 labeled as “Cancel” is operated after a plurality of business cards have been read, the whole image data accumulated in the image memory 14 is discarded, and the consolidation mode ends.

If the user operates the operation button B2 labeled as “End reading” on the touch panel, the flow proceeds to step S12, which will be described later.

If the user operates the Start button, the flow proceeds to step S5. If the user operates none of the operation buttons B1 and B2 and the Start button, steps S2 through S4 are repeated to receive operation from the user.

At step S5, the image reading portion 12 reads the image of the obverse side of the business card, and the flow proceeds to step S6.

At step S6, the control portion 20 analyzes the image data of the obverse side of the read business card to cut out a part of it along the edges of the business card and performs rotating processing to correct the inclination, and then the corrected image data is temporarily stored in the image memory 14.

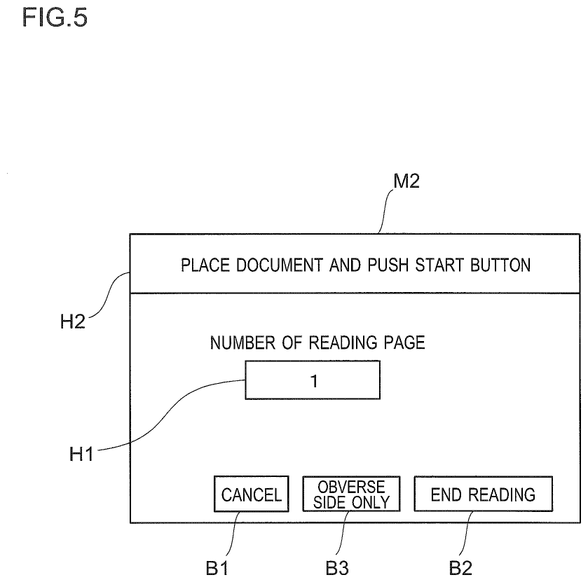

At step S7, a guidance screen M2 as shown in FIG. 5 is displayed on the display portion 11a, and the flow proceeds to step S8.

On the guidance screen M2, operation buttons B1, B2, and B3 are arranged. The operation button B3 is labeled as “Obverse side only”. A display field H1 is arranged in a middle part of the guidance screen M2, and the display field H1 indicates that “Number of pages read” is “1”. Thus, the user can confirm that the image data of the obverse side of the business card has been already read.

At steps S8, S9, S10, and S11, it is checked whether or not the control portion 20 accepts instruction input displayed on the guidance screen M2. Specifically, if the user operates the operation button B1 labeled as “Cancel” on the touch panel, the flow proceeds to step S15. At step S15, the whole data temporarily stored in the image memory 14 is deleted, and the consolidation mode ends.

If there is no image on the reverse side of the business card, the user operates the operation button B3 labeled as “Obverse side only” on the touch panel. Thus, based on the image data of the obverse side stored in the image memory 14 that was read before the operation button B3 is operated, the processed image data 52 (see FIG. 6) is generated, and the processed image data 52 (see FIG. 6) is temporality stored in the image memory 14. Back at step S1, the guidance screen M1 shown in FIG. 4 is displayed again on the display portion 11a. The user confirms that the display field H1 indicates “Number of pages read” is “0” and enters an instruction to start reading a new business card.

Here, the indication “Obverse side only” on the display portion 11a is guidance on instruction input that informs that processed image data is generated when the number of sheets from which image data is read is smaller than the previously set number of sheets to be consolidated (two in the consolidation mode with respect to the business card). By confirming the indication “Obverse side only” on the display portion 11a, the user understands that there is no need to read the reverse side of the business card.

That is, in the consolidation mode, the user performs instruction input on the operation portion 11 so that the processed image data 52 (see FIG. 6) is generated by the image reading device 70 based on the image data corresponding to the number of sheets (one) smaller than the previously set number of sheets to be consolidated. Thus, the user can skip operation for making the image reading portion 12 read unnecessary image data of the reverse side of the business card. The unnecessary image data of the reverse side is not included in the generated processed image data 52 (see FIG. 6). This improves the operability when business cards are read and the efficiency of management of image data.

On the other hand, if there is an image on the reverse side of the business card, the user places the business card in the placement reading region 30b of the image reading portion 12 with the reverse side down and operates the Start button. The flow then proceeds to step S16, where the image reading portion 12 reads the image of the reverse side of the business card, and then the flow proceeds to step S17.

At step S17, the control portion 20 analyzes the image data of the reverse side of the read business card to cut out a part of it along the edges of the business card and performs rotating processing to correct the inclination. Then, the image data of the obverse side of the business card temporarily stored in the image memory 14 and the image data of the reverse side of the read business card are consolidated to generate the processed image data 51 (see FIG. 6). At step 18, the consolidated processed image data 51 (see FIG. 6) is temporarily stored in the image memory 14, and the flow returns to step S1.

At step S1, the guidance screen M1 shown in FIG. 4 is displayed on the display portion 11a again. The user confirms that the guidance screen M1 indicates “Number of pages read” is “0” and enters an instruction to start reading a new business card. When the new business card is read, the user places the business card on the image reading portion 12 with the obverse side down and operates the Start button. Thereby, the reading of the new business card is started. By repeating steps S1 through S10 and steps S16 through S18, the user can make the image reading device 70 efficiently generate the processed image data 51 and 52 (see FIG. 6) of a plurality of business cards.

If the user operates the operation button B2 on the touch panel, the flow proceeds to step S12. If the user operates none of the operation buttons B1, B2, and B3 and the Start button, steps S8 through S11 are repeated to receive operation from the user.

At step S12, the control portion 20 arranges the generated processed image data 51 and 52 (see FIG. 6) in the order stored in the image memory 14 and edits it to generate edited data 50, and then the flow proceeds to step S13.

FIG. 6 is a diagram showing the edited data 50. A plurality of sets of processed image data 51 and 52 are arranged in the edited data 50 in the order generated, and the newer processed image data 51 and 52 are arranged the further down. The image data 51a of the obverse side is arranged in the left region of the processed image data 51 and the image data 51b of the reverse side is arranged in the right region of the processed image data 51, next to each other. Here, for processed image data 52 that has no image on the reverse side of the business card read and that is generated by operating the operation button B3 labeled as “Obverse side only”, the image data 52a of the obverse side is arranged in the left region of it, and no image data is arranged in the right region of it.

By editing the edited data 50 with the above-described configuration, the images of the obverse and reverse sides of the read business card are visually associated with each other efficiently; thus, the user can efficiently manage the image data of the read business card. The image data 51a of the obverse side and the image data 51b of the reverse side can be arranged over each other in the up-down direction.

At step S13, the control portion 20 outputs the edited data 50 and discards the whole processed image data stored in the image memory 14, and the consolidation mode ends. The control portion 20 can output the edited data 50 to the image forming portion (unillustrated) so that the edited data 50 will be printed on a sheet. The edited data 50 can be transmitted to an external computer via a network. The edited data 50 can be stored in the storage portion 15.

Although the embodiment described above deal with the operation in the consolidation mode with respect to a business card, this is not meant to limit the present disclosure. For example, when the number of sheets to be consolidated has been previously set to four, by reading the image data of four documents and consolidating image data corresponding to four sheets, it is possible to generate processed image data. Here, when the number of sheets from which image data is read is smaller than the previously set number of sheets to be consolidated (for example, when the number of sheets read is three), image data corresponding to three sheets was read before the instruction input can be consolidated to generate the processed image data 51 by a user performing instruction input on the operation portion 11.

When the number of sheets from which image data is read is smaller than the previously set number of sheets to be consolidated, for example, an operation button labeled as “Consolidation” can be displayed on the display portion 11a. Displaying the operation button labeled as “Consolidation” on the display portion 11a makes it possible to give a user guidance on instruction input that informs that processed image data is generated when the number of sheets from which image data is read is smaller than the previously set number of sheets to be consolidated.

What is claimed is:

1. An image reading device comprising:
an image reading portion is configured to irradiate with light a predetermined reading region including a region where a document is present and to read the reading region;
a control portion is configured to perform image processing on image data read by the image reading portion; and
an operation portion on which a user performs instruction input with respect to the control portion,
wherein
the control portion can operate in a consolidation mode in which the read image data is consolidated to generate processed image data when the image reading portion has read image data corresponding to a previously set number of sheets to be consolidated, and
in the consolidation mode, when a number of sheets from which image data is read is smaller than the previously set number of sheets to be consolidated, in response to instruction input on the operation portion, the processed image data is generated based on the image data read before the instruction input.

2. The image reading device according to claim 1, further comprising:
a display portion is configured to display guidance on instruction input,
wherein
when the number of sheets from which image data is read is smaller than the previously set number of sheets to be consolidated, the display portion displays guidance on instruction input that informs that the processed image data is generated.

3. The image reading device according to claim 1, wherein,
the control portion cuts out a part of the image data read by the image reading portion along edges of the document.

4. The image reading device according to claim 3, wherein,
the control portion performs rotating processing with respect to the image data read by the image reading portion to correct an inclination.

5. The image reading device according to claim 1, wherein,
in the consolidation mode, the number of sheets to be consolidated is previously set to two, and
in the consolidation mode, in response to instruction input on the operation portion, the processed image data is generated based on image data corresponding to one sheet read before the instruction input.

6. The image reading device according to claim 1, wherein,
the document is a card document.

7. An image forming apparatus comprising:
the image reading device according to claim 1.
